(19) United States
(12) Patent Application Publication
(10) Pub. No.: US 2005/0071243 A1
(43) Pub. Date: Mar. 31, 2005

(54) Non-disruptive business process debugging and analysis

(76) Inventors: Anandhi Somasekaran, Redmond, WA (US); Sergey Chub, Redmond, WA (US); Tolga Yildirim, Sammamish, WA (US); Gueorgui Bonov Chkodrov, Redmond, WA (US); Kraig S. Rury, Seattle, WA (US); Lucy Ling-Chu Chao, Bellevue, WA (US); Vladimir Pogrebinsky, Issaquah, WA (US)

Correspondence Address: WOODCOCK WASHBURN LLP, ONE LIBERTY PLACE - 46TH FLOOR, PHILADELPHIA, PA, 19103, US

(21) Appl. No.: 10/676,743

(22) Filed: Sep. 30, 2003

(51) Int. Cl. G06F 17/60

(52) U.S. Cl. 705/26

(57) ABSTRACT

A system and method of remotely debugging an orchestration service instance providing a means for establishing a communications connection with a computer, wherein the computer is executing a business process service instance. Stored tracking information regarding the orchestration service instance is read, and the orchestration service instance is remotely debugged by way of the communications connection and according to the stored tracking state information.

### FIELD OF THE INVENTION

The present invention relates generally to software development. More particularly, the present invention relates to debugging distributed transactional applications such as business process orchestration software, and to a system and method for debugging such business process orchestration software in a non-intrusive manner. Even more particularly, the present invention relates to a graphical user interface for debugging business process orchestration software.

### BACKGROUND OF THE INVENTION

A business may use a software application, such as a web service, to automate business processes and to interact with other entities in a distributed environment, such as the Internet or World Wide Web. To ensure that such interactions are accomplished successfully, one or more protocols must be in place for carrying messages to and from participants, and specific business applications must also be in place at each participant's end. Such interactions are message-driven. For example, a buyer sends a purchase order to a seller. The seller then checks its inventory to determine if it can provide the ordered items. If so, the seller sends an acknowledgement back to the buyer with a price. Finally, the buyer accepts or rejects the seller's offer (and/or possibly places another order). As evident in this example, each participant's business application reacts to the receipt of messages.

Such message-based transactions may not be completed for a relatively long period of time (e.g., if the seller takes several days to check its inventory before responding to the purchase order). As a result, information regarding the state of the application must be stored, or “persisted,” so as to complete the transaction successfully when, for example, a response is finally received. Persisting the state of the application also makes the application less prone to errors. For example, if the application is shut down due to a power failure the stored state information allows the application to resume in the same state when the application is restarted as when the failure occurred.

Accordingly, a distributed transactional application is a software application that runs in a distributed environment and persists the state of the application data in a server in a transactional manner. An example of such a distributed transactional application is business process orchestration software, which enables the automated management of multiple instances of business processes. In such software, the code that implements a particular business process is referred to as an “orchestration service,” and one or more orchestration services may run concurrently on a single “host service.”

Business process orchestrations may be implemented using a business process software language such as, for example, XLANG/s. A business orchestration product, such as Microsoft Corporation's BizTalk™ software application, allows a user to quickly design, define and deploy automated business processes that span programs, technologies, platforms and business partners. BizTalk™'s Orchestration Designer is a XLANG/s tool for designing an orchestration service that implements one or more business processes. In particular, the Orchestration Designer provides a graphical means for creating software code, where visual symbols representing a business process can be placed in a display in a “drag-and-drop” fashion to implement the business process. The Orchestration Designer thereby creates an environment that enables a user to implement a business process in an orchestration service graphically, without requiring the user to be familiar with the software code represented by the XLANG/s programming language.

An orchestration service, like any software code, needs to be tested and debugged to ensure that it works correctly. Such testing and debugging normally takes place during the design process, or at “design time,” which occurs prior to deploying the orchestration service into a host service and running the host service on a production server.

Unfortunately, not all implementation problems can be found at design time. In such cases the orchestration service may experience an unexpected error, or may fail entirely. The ability to find the cause of the problem in such cases is extremely important and urgent. For example, a loan company that discovers that an approval for a customer's loan application shows an APR that is 1% more than the rate the customer was supposed to receive must urgently find and repair the flaw in its business process software Conventionally, two technologies exist to perform such a function: a conventional debugger that attaches to the host service and a trace tool that listens for loosely-coupled events generated by the runtime that indicates the progress of the orchestration service.

Attaching a conventional debugger in a production environment is unworkable, because such a debugger would affect all other business process instances that are running in the same host service. Using the above loan example, such a conventional debugger would affect all loan applications, rather than only the affected customer's application. Furthermore, in many cases a conventional debugger is unable to determine why the problem happened because it cannot recall historical instance data.

Trace tools that fire loosely-coupled events are a small improvement over attaching a conventional debugger because other instances are not affected. Unfortunately, trace tools have numerous other shortcomings. A typical trace tool such as, for example, XLANGMon is based on subscribing to runtime events. Runtime events are loosely-coupled events, which means that they are captured only if enabled, and have no event correlation to the business process. As a result, such a trace tool presents the raw data as a tracking log with no explicit decoding. Thus, a significant shortcoming of a tracing tool such as XLANGMon is that data generated using such a tool is cryptic, and therefore not easily understandable to an end user. In addition, the data is not typically consistent with the transactional boundaries of the orchestration. Furthermore, such events are not persisted to any stable storage medium and as a result “replay mode” and/or post mortem analysis of an event is not available.

Another shortcoming of both conventional debuggers and trace tools is their machine affinity and inability to provide viewing of instances across remote hosts. As a result, any conventional debugging needs to be performed on-site, which increases the expense and inconvenience involved in debugging such an orchestration service.

Finally, another shortcoming of a conventional debuggers and trace tools is the code-based nature of the user interface. For example, a conventional debugger displays the software code that is being debugged to a user and, as a result, requires the user to be very familiar with the code. Most conventional debuggers cannot be run on production servers because of such debuggers' intrusive behavior and processing overhead associated with data collection.

In light of the above shortcomings, what is needed is a method of tracking and reviewing events at all stages of a running business process for purposes of debugging such a process. More particularly, what is needed is a method of leveraging the state-persisting nature of a business process language, such as XLANG/s to enable detailed and “post-mortem” analysis of an instance of code to be debugged without affecting other instances of that code. Even more particularly, what is needed is an orchestration debugger that provides a display of business process messages in an abstracted form of an XLANG/s message which comprises context, content properties and all of its part values in a user-friendly graphical user interface. Yet even more particularly, what is needed is an orchestration debugger that has no machine affinity and that uses the secure messaging features of XLANG/s to provide a secure remote debugging session.

### SUMMARY OF THE INVENTION

In light of the foregoing limitations and drawbacks, a system and method of remotely debugging a process service, such as a business process service is provided. In the system, a means for establishing a communications connection with a remote computer, wherein the remote computer is implementing a business process service, is provided. Stored state information regarding the business process service is read, and the business process service is remotely debugged by way of the communications connection and according to the stored state information.

In another embodiment of the system, a server runs a business process service, thereby generating runtime data. A user interface (UI) presents the business process and enables a user to place a debugging breakpoint that is transmitted to the runtime server. The server, when executing the business process, communicates to an interceptor by firing an event at an activity boundary. The interceptor, based on a user-specified breakpoint, can intercept and request a debug break for the business process instance. The server responds to such a request and transitions the instance into a debugging mode. The user can then attach to the business process instance by way of the UI and thereby establish a debugging session.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a block diagram illustrating an exemplary computing environment in which aspects of the invention may be implemented;

FIG. 2 is a block diagram illustrating an exemplary networked computing environment in which aspects of the invention may be implemented;

FIG. 3 is a block diagram illustrating an exemplary message flow in an instance of an automated business process in which aspects of the invention may be implemented;

FIG. 4 is a block diagram illustrating an exemplary debugging system in accordance with an embodiment of the present invention;

FIG. 5 is a flow chart illustrating an exemplary debugging method in accordance with an embodiment of the present invention; and

FIGS. 6A-B are screen shots illustrating an exemplary orchestration debugger graphical user interface (GUI) in accordance with an embodiment of the present invention.

### DETAILED DESCRIPTION OF ILLUSTRATIVE EMBODIMENTS

Overview

A business process debugger is provided that, in one embodiment, utilizes XLANG/s components to provide debugging functionality to distributed transactional applications. For example, in one embodiment of the present invention, a XLANG/s orchestration debugger utilizes an interceptor, which is a part of every XLANG/s orchestration business process, to track events and collect data at every activity boundary within a business process. Such tracked events directly map into the XLANG/s language and represent the business process activity being implemented by the orchestration service. As will be discussed in detail below, a debugger in accordance with an embodiment of the present invention uses such tracked events to provide a historical account of program activities and variable states during the execution of the orchestration service to be debugged.

The orchestration debugger also uses orchestration runtime components that respond to specific debug control messages. In accordance with another embodiment of the present invention, such runtime components are used to discover the client that requests the debug session and then to establish a secure remoting channel for communication. Such runtime components retrieve instance-specific business process data and also fire process instance state change events.

The orchestration debugger user interface (UI) also invokes orchestration client components that serve as middle client layer between the server and the UI. In yet another embodiment of the present invention, such client components handle the logic to route requests and send appropriate control messages. The orchestration debugger UI thereby provides a graphical debugging environment that is capable of remotely accessing and debugging an automated business process.

Exemplary Computing Environment

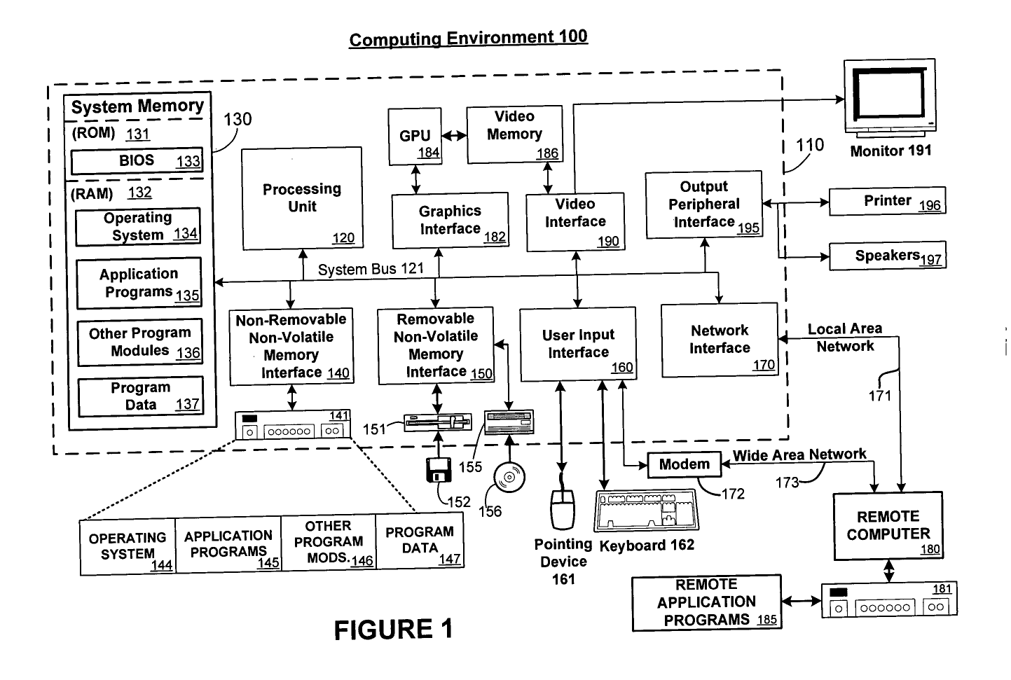

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CAROM, digital versatile disks (DVD) or other optical disk storage, magnetic cassettes, magnetic tape, magnetic disk storage or other magnetic storage devices, or any other medium which can be used to store the desired information and which can accessed by computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during startup, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 140 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Distributed Computing Frameworks or Architectures

Various distributed computing frameworks have been and are being developed in light of the convergence of personal computing and the Internet. Individuals and business users alike are provided with a seamlessly interoperable and web-enabled interface for applications and computing devices, making computing activities increasingly web browser or network-oriented.

For example, MICROSOFT®'s .NET platform includes servers, building-block services, such as web-based data storage, and downloadable device software. Generally speaking, the .NET platform provides (1) the ability to make the entire range of computing devices work together and to have user information automatically updated and synchronized on all of them, (2) increased interactive capability for web sites, enabled by greater use of XML rather than HTML, (3) online services that feature customized access and delivery of products and services to the user from a central starting point for the management of various applications, such as e-mail, for example, or software, such as Office .NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors, and (7) many other cross-platform integration features as well.

While exemplary embodiments herein are described in connection with software residing on a computing device, one or more portions of the invention may also be implemented via an operating system, API, or a “middle man” object between a coprocessor and requesting object, such that services may be performed by, supported in, or accessed via all of .NET's languages and services, and in other distributed computing frameworks as well.

Exemplary Embodiments

The description contained herein is not intended to limit the scope of this patent. Rather, the inventors have contemplated that the claimed subject matter might also be embodied in other ways, to include different elements or combinations of elements similar to the ones described in this document, in conjunction with present or future technologies.

Accordingly, it will be appreciated that an embodiment of the present invention is equally compatible with any type of stateful computer programming language that is capable of automating a distributed business process. Therefore, the description herein reflecting the use of XLANG/s is merely illustrative, as any type of equivalent language is consistent with an embodiment of the present invention. In addition, it will be appreciated that the use herein of XLANG/s-specific terminology such as, for example, “orchestration” and “interceptor” is done for the sake of clarity and in no way implies that only XLANG/s components or functionality may be used in connection with the present invention. Accordingly, any type of equivalent components and/or functionality may be used in accordance with an embodiment of the present invention.

Introduction to Web Services

Businesses are more frequently interacting via distributed environments, such as the Internet or World Wide Web. For example, a consumer may want to know the prices of rental cars for an upcoming trip. The consumer may request the prices through an intermediate business on the Internet, such as a travel website. The intermediate business, upon receiving the consumer's request, sends price quote requests to a variety of rental car businesses. After responses are received from the rental car businesses, the intermediate business then sends the responses to the consumer. The consumer may then reserve a car and pay for the reservation by way of the intermediate business. The business processes discussed above are implemented using messages. For example, the consumer's request to the intermediate business is implemented as an electronic message to the intermediate business that contains the particulars of the proposed car rental, for example: rental dates and times, type of car, additional insurance desired, consumer's name and address, credit card information and/or the like. The intermediate business' price quote request is another message, as are the responses from the rental car businesses—both to the intermediate business from the rental car businesses and from he intermediate business to the consumer—and the reservation ultimately sent by the consumer.

One computer language that is designed to automate business processes and the messages used to carry out such processes is XLANG/s, which is described in more detail, below. As may be appreciated, it is important that the business processes that are implemented using XLANG/s execute properly, and without errors. In addition, such processes should be robust enough to compensate for external errors, such as communications link failures and the like. Providing a method and system for debugging XLANG/s code to accomplish such business processes in a robust and error-free manner is an application of an embodiment of the present invention.

XLANG/s Introduction

XLANG/s is a language that describes the logical sequencing of business processes, as well as the implementation of the business process by using various technology components or services. XLANG/s is described in more detail than is disclosed herein in a document titled “XLANG/s Language Specification,” Version 0.55, Copyright© Microsoft 1999-2000, and a document titled “XLANG Web Services For Business Process Design,” Satish Thatte, Copyright© Microsoft Corporation 2001, both of which are hereby incorporated by reference in their entirety. The XLANG language is expressed in Extensible Markup Language (XML). XLANG/s is a modern, domain specific, special purpose language used to describe business processes and protocols. XLANG/s is also a declarative language, which means that it defines an explicit instruction set that describes and implements steps in a business process, the relationship between those steps, as well as their semantics and interactions. In addition, XLANG/s code is not just descriptive; it is also designed to be executable. Because of the declarative nature of XLANG/s and its specific semantics, the resulting executable code is deterministic; that is, the behavior of the running business process is well defined by the semantics of the collection of XLANG/s instructions. Therefore, by examining XLANG/s code one is able to determine the business process that is carried out by such code. As noted above, the definition of such a business process in executable form is an “orchestration service.”

XLANG/s is compatible with many Internet standards. XLANG/s is designed to use XML, XSLT (http://www.w3.org/TR/xslt), XPATH (http://www.w3.org/TR/xpath), XSD (XML Schema Definition) and WSDL (Web Services Description Language) as supported standards and has embedded support for working with .NET based objects and messages. WSDL is described in a document titled “Web Services Description Language (WSDL) 1.1,” W3C Note January 2001, by Microsoft and IBM Research, Copyright D 2000 Ariba, International Business Machines Corporation, Microsoft, and is hereby incorporated by reference in its entirety. The XLANG/s language is syntactically similar to C#, thus a C# specification may also be referenced as an aid to understanding the exact syntax. The semantics embodied in XLANG/s are a reflection of those defined in a document entitled “Business ProcessExecution Language for Web Services,” Version 1.1, dated Mar. 31, 2003, published by Microsoft, IBM and BEA for the definition of Business Process semantics, which is also hereby incorporated by reference in its entirety. The Business Process Execution Language for Web Services specification is commonly referred to as the “BPEL4WS” specification. As may be appreciated, therefore, the use of XLANG/s is most advantageous when applied to a business process.

XLANG/s defines a rich set of high-level constructs used to define a business process. XLANG/s statements generally fall into one of two categories: simple statements that act on their own, such as receive or send, and complex statements that contain or group simple statements and/or other complex statements. XLANG/s also supports low-level data types such as strings or integers, for example. High-level data types are also defined such as, for example, messages, ports (locations to which messages are sent and received), correlations and service links. The data types are used to rigorously define the semantics associated with the business process.

As noted above, a XLANG/s service communicates with the outside world by sending and/or receiving messages. The message type is the structural definition of such a message. Messages are acted upon by operations (e.g., receive, response), and an operation may be either a single asynchronous message or a request-response pair of messages. Operations may be either incoming or outgoing. For example, a seller may offer a service/product that begins an interaction by accepting a purchase order (from a potential buyer) by way of an input message. The seller may then return an acknowledgement to the buyer if the order can be fulfilled. The seller may send additional messages to the buyer (e.g., shipping notices, invoices). Typically, these input and output operations occur in accordance with a defined sequence, referred to as a “service process.” The seller's service remembers the state of each purchase order interaction separately from other similar interactions. This is particularly advantageous in situations in which the buyer may be conducting many simultaneous purchase processes with the same seller. Also, each instance of a service process may perform activities in the background (e.g., update inventory, update account balance) without the stimulus of an input operation.

A service process may represent an interaction utilizing several operations. As such the interaction has a well-defined beginning and end. This interaction is referred to as an instance of the service. An instance can be started in either of two ways. A service can be explicitly instantiated using some implementation-specific functionality or a service can be implicitly instantiated with an operation in its behavior that is meant to be an instantiation operation. A service instance terminates when the process that defines its behavior terminates.

Services are instantiated to act in accordance with the history of an extended interaction. Messages sent to such services are delivered not only to the correct destination port, but to the correct instance of the service that defines the port. A port is an end point where messages are sent and received by a service. The infrastructure hosting the service supports this routing, thus avoiding burdening every service implementation with the need to implement a custom mechanism for instance routing.

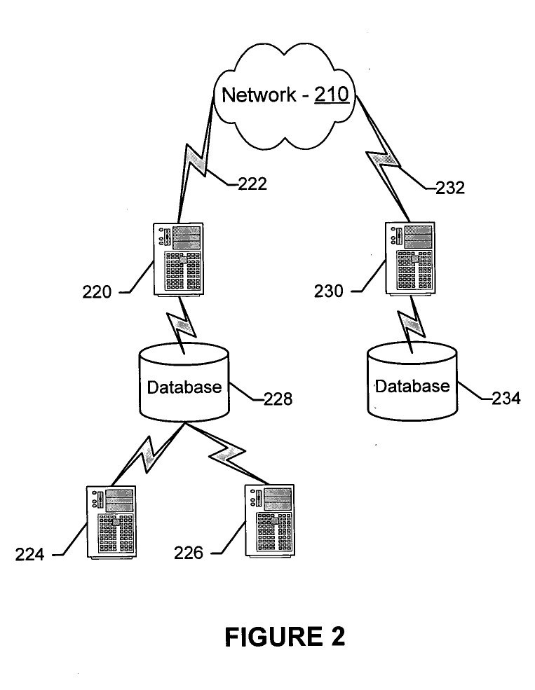

Turning now to FIG. 2, a simplified, exemplary computer network for enabling communications between two business entities is illustrated. A first computer 220, which is any type of computing device such as, for example, computer 110 as disclosed above in connection with FIG. 1, a special-purpose computer or the like, is operatively connected to a network 210 by way of communications link 222. First computer 220 is also operatively connected to a database 228, which in one embodiment contains business process-specific information as will be discussed below. Network 210 may be any type of network for interconnecting a plurality of computing devices, and may be an intranet, the Internet, etc. Communications link 222 may comprise any type of communications medium, whether wired, wireless, optical or the like. Second computer 230, like first computer 220, may be any type of computing device, and is operatively connected to network 210 by way of communications link 232. As can be seen in FIG. 2, second computer 230 is also operatively connected to a database 234.

Communications link 232, like communications link 222, may be any type of communications medium. In one embodiment, communications links 222 and 232 are the same type of communications medium, while in another embodiment the medium employed by each communications link 222 and 232 is different. In FIG. 2, it can be seen that first computer 220 is also operatively connected to computers 224 and 226 by way of database 228. As may be appreciated, additional computers may be operatively connected to second server 230 as well (not shown in FIG. 2 for clarity). It will be appreciated that, although described herein as computers 220, 224, 226 and 230, such computers may be a client or a server computer, or a combination of both, depending on the exact implementation of the computer network and the relationship between computers during a transaction. It will also be appreciated that any combination or configuration of computers and databases is equally consistent with an embodiment of the present invention.

For example, consider a typical supply chain situation in which a buyer sends a purchase order to a seller. The buyer sends the message from, for example, first computer 220 to the seller's second computer 230 by way of the network 210 and communications links 222 and 233. Assume, for example, that the buyer and seller have a stable business relationship and are statically configured—by way of settings stored in databases 228 and 234—to send documents related to the purchasing interaction to the URLs associated with the relevant ports. When the seller returns an acknowledgement for the order, the acknowledgement is routed to the correct service instance at the buyer's end at first computer 220 or, optionally, another computer such as additional computer 224 or 226, by way of database 228. One way to implement such a routing is to carry an embedded token (e.g., cookie) in the order message that is copied into the acknowledgement for correlation. The token may be in the message “envelope” in a header or in the business document (purchase order) itself. The structure and position of the tokens in each message can be expressed declaratively in the service description. This declarative information allows XLANG/s-compliant infrastructure to use tokens to provide instance routing automatically.

In one embodiment of the present invention, another function of databases 228 and 234 is to serve as a repository for persisted state information for any instances of an orchestration service. For example, first computer 220 transmits a message to second computer 230 in accordance with a service process for a currently-running orchestration service. Upon first computer 220 sending the message, database 228 records the state information for the instance. In such a case, the state information may record that a message has been sent to second computer 230, the content of a message, and that the first computer 220 is waiting for a response. Upon the occurrence of second computer 230 receiving first computer's 220 message, database 234 records the state information for the instance. In the present example, such state information indicates that a message from first computer 220 was received, the contents of such message and that a response must be generated.

Accordingly, if a communication error or power interruption occurs, upon resolution of the problem first computer 220 will know that it has sent a message to second computer 230 and is currently waiting for a response, and second computer 230 will know that it has received a message from first computer 220 and must generate a response. In addition, the storage of state information for an instance of an orchestration service enables the processing of long-running transactions. For example, the business process being implemented by the orchestration service may take a long period of time to generate a response to the message. In such a case, both first and second computers 220 and 230 can process other orchestration services and then return to the instance at the correct point in its service process once the response is generated.

During its lifetime, a service instance may typically hold one or more conversations with other service instances representing other participants involved in the interaction. Conversations may use a sophisticated transport infrastructure that correlates the messages involved in a conversation and routes them to the correct service instance. In many cases, correlated conversations may involve more than two parties or may use lightweight transport infrastructure with correlation tokens embedded directly in the business documents being exchanged. XLANG/s addresses correlation scenarios by providing a very general mechanism to specify correlated groups of operations within a service instance. A set of correlation tokens can be defined as a set of properties shared by all messages in the correlated group. Such a set of properties is called a correlation set.

Description of Embodiments of the Present Invention

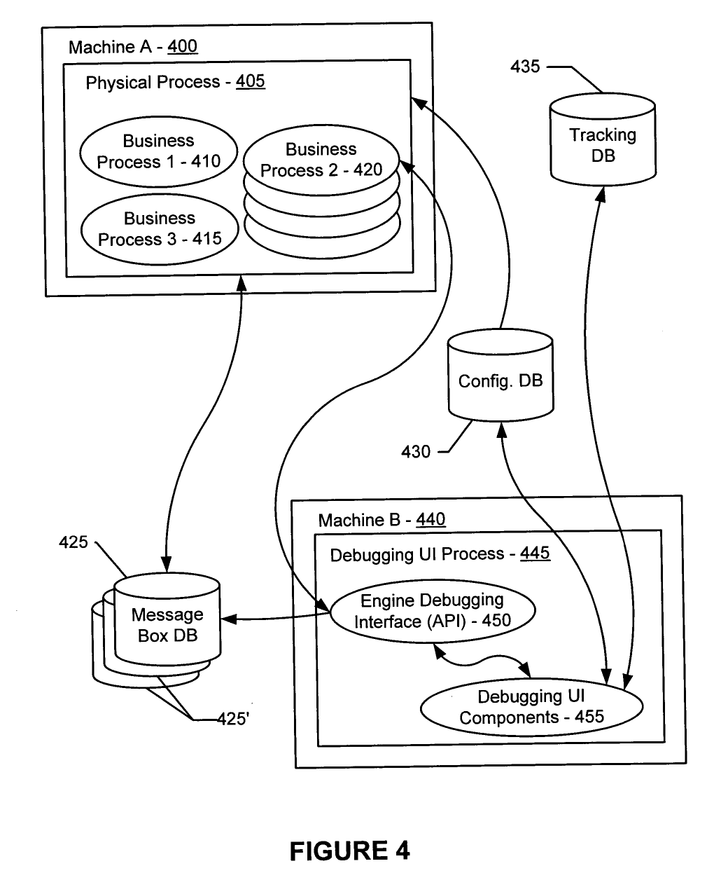

As may be appreciated, the aforementioned Orchestration Designer utilizes a graphical UI (GUI) that represents XLANG/s code that performs an operation as a visual object that may be placed on a display device in a “drag and drop” manner or the like. When a user places a visual object, or “shape,” representative of a particular operation, the code that carries out the shape's activities is automatically created by the Orchestration Designer. In addition, information regarding the operation represented by the shape is stored in an XML- or XML-type—document, as will be discussed below in greater detail in connection with FIG. 4. Such information may include, but is not limited to, a shape identifier, type of the shape, user-provided name of the operation, the messages that are received and sent by the shape, and the like. It will be appreciated that, during the compilation process (at “compile time”), such information may be assembled into a storage of orchestration information (an XML document as well) that describes each shape in the orchestration, the orchestration itself, as well as any other information regarding the service process or the like.

Accordingly, a debugger according to an embodiment of the present invention uses such a storage of orchestration information to provide debugging functionality as well as a debugging environment that closely resembles the design environment. For example, and as will be discussed below, the information may be displayed to a user in the debugging GUI to enable the user to select instances, operations or messages within instances, or the like, for an orchestration of interest. In an embodiment, the information is used to recreate the graphical representation of the orchestration in the debugging environment so as to create a debugging environment that is familiar to the user as being similar to the design environment of the Orchestration Designer.

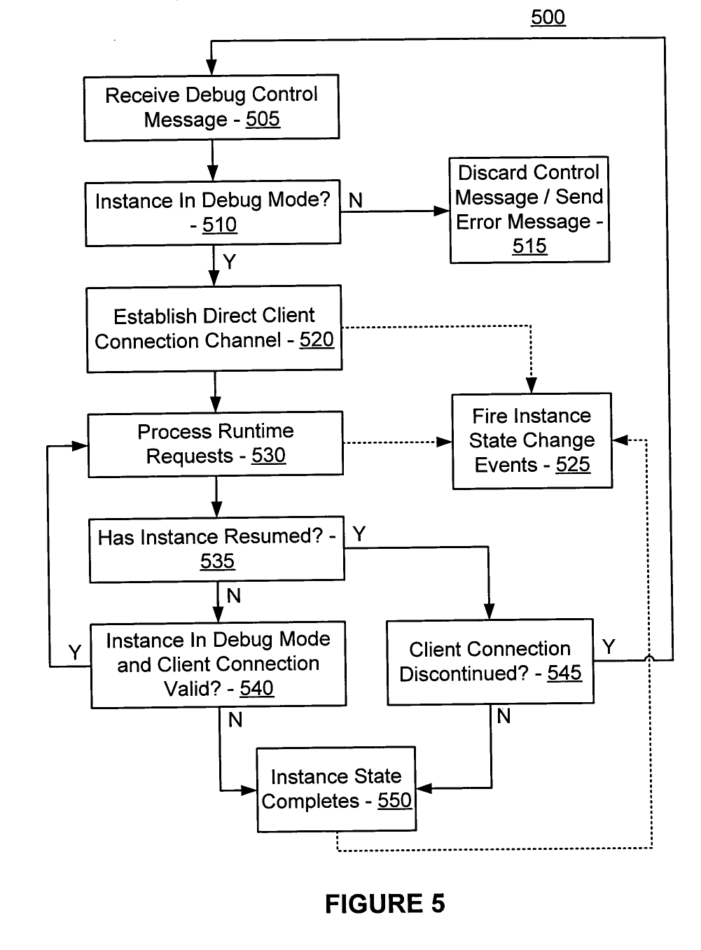

In an embodiment of the present invention, the stored orchestration information also permits the debugger to access a particular instance of an orchestration at a time and/or place desired by a user. For example, the orchestration information may include the beginning and end points of an operation in each instance of an orchestration. As a result, a user may, for example, use a pointing device such as a mouse, or a hot key to insert a debugging break point or the like within the graphically-displayed orchestration and before and/or after a shape of interest. As may be appreciated, and as will be discussed below in connection with FIGS. 4 and 5, in such a manner any type of interaction with the orchestration may be made available to a user of the debugger.

Accordingly, and as discussed above, a method and system of debugging a distributed transactional application implemented in XLANG/s is provided herein. As was discussed above in the “XLANG/s Introduction” and in connection with FIG. 2, XLANG/s persists the state(s) of an application in one or more databases. Therefore, in an embodiment of the present invention, and in addition the stored orchestration information, the state-persisting functionality of XLANG/s is used to store and provide state information about, for example, a failed instance of an orchestration service or the like. As may be appreciated, such state information may be used by an embodiment of the present invention for debugging such an instance in accordance with the methods and systems described herein. In addition, and as was also described above, XLANG/s implements message-based transactions and therefore has an infrastructure for the secure, remote interconnection of computing devices using, for example, .NET remoting channels. Accordingly, in an embodiment of the present invention, such infrastructure, along with the aforementioned stored state information, is utilized to provide remote debugging capabilities.

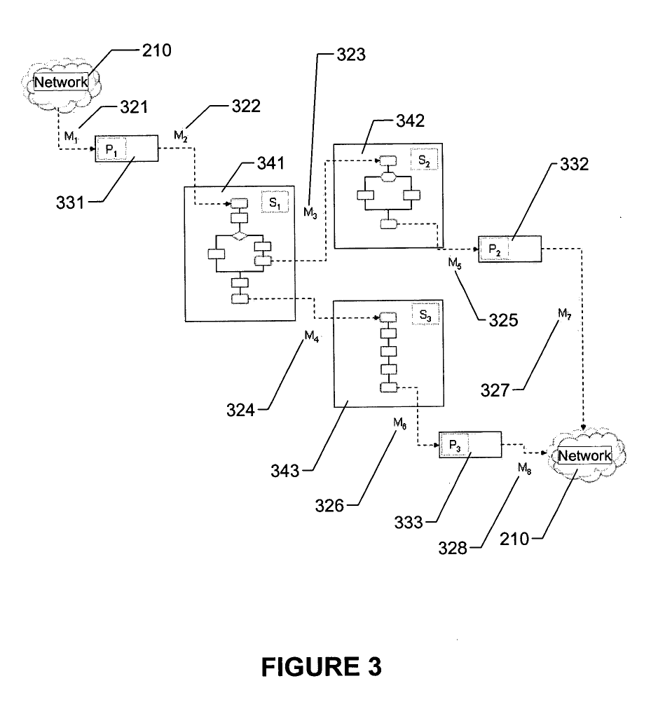

Turning now to FIG. 3, a block diagram illustrating an exemplary message flow in an instance of an automated business process in which aspects of the invention may be implemented is provided. It will be appreciated that the exemplary components illustrated in FIG. 3 are illustrative only, as any configuration of any number of messages, ports and business processes may be present in an embodiment of the present invention, and such instance may be part of any type of orchestration carrying out any type of business process. In addition, it will be appreciated that such messages, ports and business processes may be carried out by computers such as computers 220, 224, 226 and 230, as well as databases 228 and 234, and the like, as was discussed above in connection with FIG. 2. Thus, in the exemplary configuration of FIG. 3, a message M₁ 321 is received into receive port P₁ 331 from network 210. Network 210, as was discussed above in connection with FIG. 2, may be an intranet, the Internet or the like. Message M₁ 321 may be any type of message that is a part of the automated business process and may contain any type or quantity of information. As can be seen in FIG. 3, dashed lines indicate the flow of messages M₁₋₈ 321-328.

At receive port P₁ 331, the message M₁ is, for example, processed for signature verification and decrypted and then sent as message M₂ 322. Message M₂ 322 is received by business process S₁ 341. Business process S₁, for example, parses individual fields values in message M₂ 322, takes actions according such field values, executes some user code—as represented by the illustrative flowchart within business process S₁—and creates new messages M₃ 323 and M₄ 324. Messages M₃ 323 and M₄ 324 are then sent to business processes S₂ 342 and S₃ 343 for further processing. The outcomes of business processes S₂ 342 and S₃ 343, messages M₅ 325 and M₆ 326, respectively, are sent to transmit ports P₂ 332 and P₃ 333, respectively, to be signed and encrypted. Finally, transmit ports P₂ 332 and P₃ 333 transmit messages M₇ 327 and M₈ 328, respectively, to the network 210.

As may be appreciated, in the exemplary message flow of FIG. 3, any one of the business processes S₁₋₃ 341-343 may fail for any number of reasons. Data corruption, transmission errors and the like may cause any of the business processes S₁₋₃ 341-343 to be unable to complete successfully. Accordingly, and as discussed above, a user may need to debug the message flow to enable such message flow to operate properly. While it is important for a user to understand which business process S₁₋₃ 341-343 has failed, as well as any error code associated with the failure, it is also essential for the user to understand which message M₁₈ 321-328 has caused such failure. The user may even need to find out the content of, for example, the original message M₁ 321 that was received by receive port P₁ 331.

A user of a debugger in accordance with an embodiment of the present invention is able to, among other things, see what events occurred previously in the desired business process after the process has completed successfully or failed with an error or the like. Such a user is able to see such events before the process hits an inserted breakpoint. In addition, such a user is able to view historical message flow information such as, for example, which message(s) were constructed at run time due to processing a received message, in which order different run time components performed a business process operation as a result of message processing and the like. It will be appreciated that several preliminary steps take place to enable an embodiment of the present invention to provide such functionality.

For example, when the business process is developed by a user, the user drags and drops one or more shapes in, for example, the BizTalk™ development environment. With each shape, a unique identifier is generated by the environment. Such an identifier for each shape is saved when the business process metadata is saved. When the business process is compiled into an assembly format, this information is also compiled into the assembly. When the assembly is deployed, this information is extracted and put into a database such as, for example, databases 425, 430 and/or 435 as will be discussed below in connection with FIG. 4. Thus, a debugger according to an embodiment is able to reference the saved identifiers and associate tracked events to the corresponding shapes in the graphical representation. When an instance of the business process is executed, an “interceptor,” which is a XLANG/s interface that is defined by the XLANG/s runtime, collects information on shapes that have started, shapes that have ended, messages sent and received, and the like, in a particular service. Such data is also persisted into a database.

Turning now to FIG. 4, an exemplary debugging system in accordance with an embodiment of the present invention is disclosed. As discussed above, distributed transactional applications implemented using XLANG/s involve remotely connected computing devices having databases for containing state information and other information. However, and as will be appreciated, all of the machines and databases discussed herein in connection with FIG. 4 may be on the same computing device. For example, a single machine, such as computer 110 of FIG. 1, may run the debugger as well as the orchestration runtime. However, it will also be appreciated that in many embodiments such devices will be operated in separate devices, as is shown in FIG. 4, herein. In addition, in one embodiment the databases, and/or the devices in which the databases are operating, may change during a debugging session. A business process instance can be processed by multiple machines and its instance state can be optionally stored in multiple databases. The business process can be remotely debugged with no prior knowledge of the runtime server machine or database where the instance state is stored.

As can be seen in FIG. 4, machine 400 processes a physical process 405. Machine 400—as well as machine 440, as will be discussed below—may be any type of computing device such as, for example, computer 10 as disclosed above in connection with FIG. 1. Physical process 405 corresponds to the runtime of an orchestration service that comprises several business processes, such as business processes 410-420. As may be appreciated, the orchestration represented by physical process 405 may comprise any number of business processes 410-420. Machine 440 runs a orchestration debugging UI process 445. The debugging UI process may be, for example, a Health and Activity Tracking (HAT) client that will be discussed in greater detail below.

The debugging UI process 445 has, for example, a secure Security Support Provider Interface (SSPI) implementation over .NET remoting channels. Therefore, an embodiment of the present invention has a secure channel of communication between the client (machine 440) and the server (machine 400). When the debugging UI process 445 needs to debug an orchestration service instance that is implementing one or more of business processes 410-420, it deposits a message to the message box database 425 by way of an engine debugging interface 450. The engine debugging interface 450 may be any type of standalone computer program, or component—such as an application program interface (API)—that is capable of communicating with the message box database 425 and any business process 410-420. As may be appreciated, the message box database 425 may comprise a plurality of databases, as illustrated by databases 425′. Databases 425′ may perform specialized tasks such as, for example, receiving messages for certain business processes 410-420 or instances, or the like.

It will be appreciated that information from the runtime of the physical process 405 is deposited into the message box database 425 so as to provide a source of runtime data. In an embodiment of the present invention, routing logic is provided in the message box database 425 that discovers the machine where the service instance is hosted in the orchestration runtime server (machine 400). In addition, a client request such as, for example, a debugging request, as will be discussed below, may be sent to the runtime by way of the message box database 425. As will be discussed in greater detail in connection with FIG. 5, machine 400 receives a notification of the client request. It will be appreciated that in an embodiment the message sent by the debugging UI process 445 contains enough information for machine 400 to discover the client (machine 440) and “attaches” to it, so as to be able to communicate with the debugging UI process 445.

Once the service instance is in an “attached” mode, the machine 440 can request a service instance state such as, for example, XLANG/s port properties, XLANG/s service link properties, messages and message part values and properties, local variables for all the available XLANG/s scopes, and the like. In one embodiment, such a request may be sent by a debugging UI component 455. Such a UI component 455 is in operable communications with engine debugging interface (API) 450 and communicates with physical process 405 by way of a configuration database 430. The configuration database 430 contains configuration information that is used by an interceptor (as will be discussed below), so as to, for example, stop the runtime of a particular instance of interest at the time requested by the machine 440.

In addition, a tracking database 435 tracks any actions, changes and the like that the debugging UI component 455 may communicate to the physical process 405. As a result, the tracking database 435 is capable of displaying a history of the workflow, or message flow, of any of the business processes 410-420. In one embodiment, a request is transmitted by authenticating the user and encrypting the data representing the request over a secure SSPI channel. Additional security or administrative procedures may also take place. For example, when machine 400 connects back to machine 440 directly after the initial session is established, machine 400's identity may be validated.

As noted above, an embodiment of the present invention utilizes an interceptor. In such an embodiment, in order for machine 400 to keep tack of the message flow within a particular instance of an orchestration service, the interceptor tracks small streams of information about the execution while any or all of the business processes 410-420 are executed. In one embodiment, the interceptor collects data about which business process 410-420 has started, when the process has started, which message the process has received or sent, when the process ended, whether the process has succeeded or failed and the like. Such tracked information may be stored as a set of tables in a database, such as databases 425, 430 and 435, and may be published out to other services. As will be discussed below in connection with FIG. 5, in one embodiment the interceptor monitors the tracked information so as to enable, for example, UI component 455 to stop the runtime of an instance at a desired point for debugging purposes. As noted above in connection with FIG. 3, in one embodiment message flow data is stored so a user may access such data for debugging purposes.

As noted above, databases 425, 430 and 435 contain information relating to the runtime of a particular orchestration. In an embodiment of the present invention, within each database 425, 430 and 435 are tables of data relating to the information tracked by each database 425, 430 and 435. Exemplary tables of data, and exemplary means for querying the tables, is disclosed herein for illustrative purposes only. It will be appreciated that data may be organized in any manner, and any such manner is equally consistent with an embodiment of the present invention. It will also be appreciated that the syntax of the exemplary queries below are illustrative only, as any type or form of query syntax may be used according to an embodiment of the present invention.

For example, in one embodiment, all business process related information is kept in the “BusinessProcess” table, while message-related information is kept in a “Message” table. The “MessageEvent” table binds the BusinessProcess and Message tables. A message such as, for example, message M₁ 321 as disclosed above in connection with FIG. 3 above, can be sent from a business process 410-420, or received by a business process 410-420 and information relating to the message is kept in the MessageEvent table as an “EventType” field. By using such information, the following exemplary query can find all the messages that are sent or received by a business process such as, for example, business process S₁ 341:
SELECT *
FROM Message m
JOIN MessageEvents me ON m.MessageId=me.MessageId
WHERE me.ProcessId=S1.

Likewise, if a user possesses an identifier of the message, it is possible for the user to query the tables discussed above to determine which business processes if any, have received or sent this message. The following query is an example of retrieving all the business processes that have received a message M₁:
SELECT *
FROM BusinessProcess bp
JOIN MessageEvents me ON bp.ProcessId=me.ProcessId
WHERE me.MessageId=M1 and me.EventType=<ReceiveCode>.

Thus, such queries enable a user to find all the business processes that performed a given action (e.g., send or receive) with this particular message. As may be appreciated, any type of query may be available to a user to permit the user to determine any amount of information about an instance of an orchestration, business process or the like.

Referring now to FIG. 5, a flow chart illustrating an exemplary debugging method in accordance with an embodiment of the present invention is provided. It will be appreciated that the method of FIG. 5 is illustrated from the perspective of a server such as, for example, machine 400 as discussed above in connection with FIG. 4, and that the steps described herein take place in a system such as the system of FIG. 4. Thus, at step 505, a debug control message is received by a server (such as machine 400) from a client (such as machine 440). Such message, as noted above in connection with FIG. 4, contains enough information for the server to identify and communicate with the client, and contains a notification that a debugging session needs to be established. As may be appreciated, the use of an asynchronous message such as the message described herein, in connection with the logic inherent in the runtime of the orchestration, permits the runtime to distinguish which instance of the orchestration is affected and to communicate with the HAT UI accordingly. As a result, only the instance of the orchestration that is to be debugged is affected, and any other instances in the orchestration or process may continue running as they are unaffected by the debugging process.

Step 505 may be initiated, for example, when a user operating the HAT UI decides to place a break point at a desired point on a shape, which represents a particular operation in an instance of an orchestration, and run the instance for debugging purposes. In one embodiment, the interceptor waits for the runtime to send it information indicating that the runtime has reached the desired operation. As noted above, the runtime tells the interceptor where it is in a process and what shape or the like it is running, and the interceptor compares that information to any user requested breakpoints stored in, for example, the configuration database 430. Therefore, when the interceptor receives notice, for example, that the runtime has reached a point in the orchestration that corresponds to a point at which the user preset a breakpoint, the interceptor uses the runtime's callback interface and request a debug break action and will essentially render the orchestration instance in “debug mode” state.

The HAT UI, on the receipt of a user's debug session request, sends a debug control message to the orchestration instance through the underlying message box layer at step 505. At step 510, the server determines whether the particular instance specified in the debug control message is currently in debug mode. The determination of step 510 is made so as to avoid interfering with instances that are currently processing information for a currently-running orchestration. Thus, if the determination of step 510 reveals that the specified instance is not in debug mode, the server discards the message and takes no action with respect to the instance. In one embodiment of the present invention, an error message is generated and sent to the client to indicate that the instance is not in debug mode and is, for example, displayed to the user in the HAT UI that is running on the client.

If, at step 510, the determination is that the instance is in debug mode, at step 520 a connection is made to the client. As may be appreciated, in the system of FIG. 4, discussed above, the connection to the client allows the server and client to communicate without passing messages through the message box 425. As may also be appreciated, such a connection is consistent with .NET remoting techniques. Therefore, step 520 may include, for example, security checks to make sure the client is trusted, opening a TCP/IP port on which the client can listen to receive messages from the server, and the like. At step 525, as well as at steps 530 and 550 as will be discussed below, instance state change events may be fired by the server in response to client requests. For example, an instance may be taken into and out of debug mode, depending on the operation being requested by the client, or by external control messages such as, for example, a termination request or shutdown of the runtime server.

At step 530, debugging requests received from the client are processed. Such requests may comprise, for example, requests for information regarding the instance, operation, messages, variable states, callstacks of service or the like that may be used for debugging purposes. At the completion of step 530, a determination is made at step 535 as to whether the instance has resumed. As may be appreciated, the user may have requested a break point, for example, at a specified shape. Once the server has returned all the required information about the state of the instance at such point, the user may wish the instance to resume its processing—and continue until another break point, or to the end of the instance is reached. Thus, if the instance has resumed, the method continues at step 545, as discussed below. If the instance has not resumed, thereby indicating the possibility of another runtime request, a determination is made at step 540 as to whether the instance is in debug mode and whether the client connection is still valid. If so, the method of FIG. 5 returns to step 530 to process another runtime request. If not, at step 550 the instance state resumes towards completion, and an instance state change event is fired at step 525.

At step 545, a determination is made as to whether the client connection has discontinued and, if so, the method returns to step 505 to receive any debug control messages. If the client connection has not been discontinued and the user has resumed the instance, the instance state resumes towards completion at step 550, and an instance state change event is fired at step 525.

As noted above, in one embodiment, the present invention has a GUI. In such an embodiment, to generate a UI when the debugger launches, the debugger loads events that have previously occurred as collected by the interceptor and persisted into the tracking database 435, as discussed above in connection with FIG. 4. As may be appreciated, when a user is able to obtain the tracked information and shape information previously extracted in the database, the user is able to view and correlate what has occurred in the business process. A user can, for example, obtain all the events that have happened in a business process such as, for example, business process S1 341 of FIG. 3, above, by using the following exemplary query:
SELECT *
FROM DebugTrace
WHERE ProcessId=S1
ORDER BY EventTime.

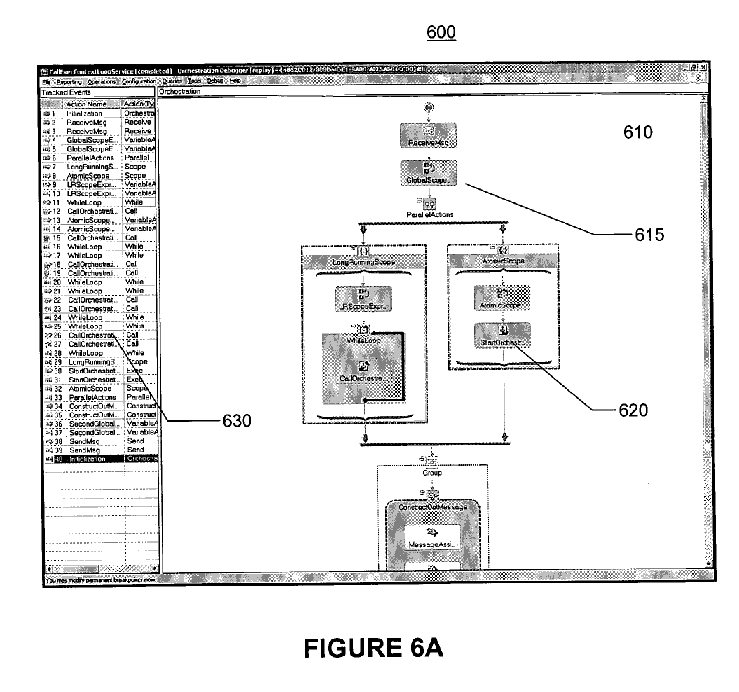

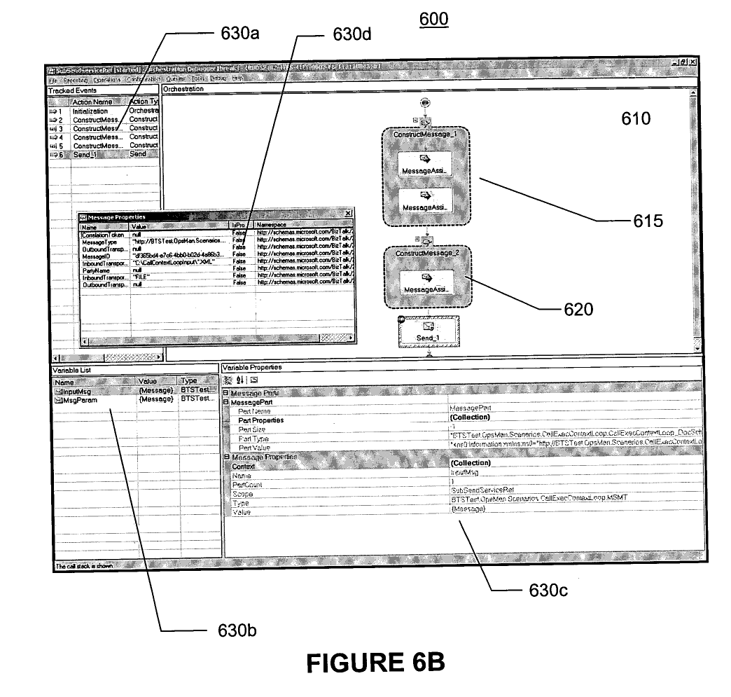

Once the debugger has obtained all the events related to actions, in one embodiment, the debugger associates this information with the shape information deployed in the database and thus shows the user the history of the business process. Therefore, and turning now to FIGS. 6A-B, are screen shots illustrating an exemplary orchestration debugger graphical user interface (GUI) in accordance with an embodiment of the present invention is shown. As may be appreciated, FIGS. 6A-B are merely illustrative, as any configuration of GUI components may be used, and any such configuration is equally consistent with an embodiment of the present invention.

In FIG. 6A, an illustrative UI 600 in accordance with one embodiment of the present invention—such as, for example, a HAT UI—is shown. Within UI 600 is an orchestration view window 610 in which a symbolic representation, such as a workflow or message flow, of an instance 615 of an orchestration, or the like, may be displayed. The shape 620 represents an operation that is carried out by the instance 615. The data window 630 displays information about the shapes 620 displayed in the orchestration view window 610.

In FIG. 6B, an illustrative UI 600 is shown with a configuration of displayed information according to another embodiment of the present invention. Within the orchestration view window 610, as was the case with FIG. 6A, above, instance 615 is displayed as a combination of shapes 620. Data windows 630a-d display four different types of information about the shapes 620 of instance 615. For example, data window 630a displays tracked events of instance 615. Data window 630b displays a list of variables used in the instance 615, while data window 630c displays properties of such variables. Finally, data window 630d displays properties of messages sent and/or received by instance 615. As may be appreciated, therefore, a UI 600 according to an embodiment of the present invention may display any type of information regarding an instance 615, orchestration or the like for debugging purposes. In addition, and as noted above, any type of configuration of such information, UI 600 controls and the like is equally consistent with an embodiment of the present invention.

Thus, a method and system for debugging business process application software has been provided. While the present invention has been described in connection with the exemplary embodiments of the various figures, it is to be understood that other similar embodiments may be used or modifications and additions may be made to the described embodiment for performing the same function of the present invention without deviating therefrom. For example, one skilled in the art will recognize that the present invention as described in the present application may apply to any type or configuration of process automation software in any type of application environment. Therefore, the present invention should not be limited to any single embodiment, but rather should be construed in breadth and scope in accordance with the appended claims.

1. A business process service debugger for remotely debugging a business process service, comprising:
means for establishing a communications connection with a remote computer, wherein the remote computer is implementing the business process service;
means for reading stored state information regarding the business process service; and
means for remotely debugging the business process service by way of the communications connection and according to the stored state information.

2. The business process service debugger of claim 1, further comprising means for displaying the business process service as a graphical image.

3. The business process service debugger of claim 2, wherein the graphical image comprises a workflow.

4. The business process service debugger of claim 2, further comprising means for interacting with the business process service according to a user instruction.

5. The business process service debugger of claim 1, wherein the stored state information corresponds to a variable assignment within the business process service.

6. The business process service debugger of claim 1, wherein the stored state information is stored in a database.

7. The business process service debugger of claim 1, wherein the stored state information corresponds to message flow data.

8. The business process service debugger of claim 1, wherein said reading means further comprises means for reading stored business process service configuration information.

9. The business process service debugger of claim 1, wherein said establishing means further comprises means for maintaining communications across a plurality of remote computers.

10. The business process service debugger of claim 1, wherein said debugging means comprises means for detecting a location where the instance is being processed.

11. The business process service debugger of claim 1, wherein said debugging means comprises means for detecting a location where the instance state is being stored.

12. A system for remotely debugging a distributed transactional application, comprising:
a server, wherein the server runs a business process service, thereby generating runtime data;
a client computer for running a debugging user interface (UI) process, wherein the UI process establishes a communications connection with the server according to a user instruction, and further generates a runtime request pertaining to a location within the business process service; and
an interceptor for identifying the location within the business process service according to the runtime data and, when the location is identified, causing the server to carry out the runtime request.

13. The system of claim 12, further comprising a database for receiving the runtime data and for storing business process service state information.

14. The system of claim 13, further comprising a display device, wherein the display device presents a shape corresponding to the business process service based on the business process service state information, and an input device, wherein the input device receives the user instruction.

15. The system of claim 14, wherein the display device further presents a workflow representative of the program flow of the business process service.

16. The system of claim 14, wherein the display device further presents data representative of the message flow of the business process service.

17. The system of claim 14, wherein the shape is presented according to stored state information.

18. The system of claim 12, wherein the database comprises a first database for receiving the runtime data and storing un-decoded tracking data and a second database for decoding and storing business process service tracking status information.

19. The system of claim 18, wherein the UI process comprises an application program interface for communicating with the first database.

20. The system of claim 18, wherein the UI process comprises a UI component for communicating with the second database.

21. The system of claim 18, wherein the first database is a message box database.

22. The system of claim 18, wherein the second database is a tracking database.

23. The system of claim 12, wherein the interceptor is a component of a computer language that provides stored state tracking information.

24. The system of claim 12, wherein the UI process detects a location where the instance is being processed.

25. The system of claim 12, wherein the UI process detects a location where the instance state is being stored.

26. A method for debugging a business process service instance running on a remote computer, comprising:
if the business process service is in a debug mode, establishing a direct client connection channel with the remote computer;
causing an interceptor to monitor data regarding the business process service to find a location within the service based on stored state information;
receiving a runtime request; and
processing the runtime request at the remote computer with respect to the location within the instance.

27. The method of claim 26, further comprising:
querying a database containing a status of the business process service;
displaying a query result on a display device;
receiving user input with respect to the query result; and
establishing the direct client connection channel in response to the user input.

28. The method of claim 27, wherein the information contained in the database is instance runtime data.

29. The method of claim 27, wherein the information contained in the database is instance tracking data.

30. The method of claim 26, further comprising:
creating the business process service using a process designer;
saving a business process service configuration and symbolic data in a database;
displaying a graphical representation of the business process service on a display device according to the saved business process service symbolic data;
generating a runtime request based on the graphical representation; and
displaying a result of the runtime request on the display device.

31. The method of claim 30, wherein the graphical representation comprises a shape corresponding to an operation in the business process service.

32. The method of claim 30, wherein the graphical representation comprises a workflow representation of the business process service.

33. The method of claim 30, wherein the saving step takes place in connection with compiling and deploying the business process service.

34. The method of claim 30, wherein the business process service is implemented in a computer language that provides stored state information.

35. The method of claim 30, wherein the interceptor request is a break point.

36. The method of claim 30, wherein the runtime request is a request for data regarding an instance of the business process service.

37. The method of claim 36, wherein the data regarding the instance is state information.

38. The method of claim 26, further comprising detecting a location where the instance is being processed.

39. The method of claim 26, further comprising detecting a location where an instance state is being stored.

40. A method in a computer system for displaying on a display device a business process service debugger, the method comprising:
querying a database for tracking information regarding the business process service, wherein the tracking information contains an operation identifier;
receiving a query result and generating a shape representative of the operation according to the identifier; and
presenting the shape, the tracking information according to the query result, and a debugging option on the display device.

41. The method of claim 40, further comprising receiving runtime data for the business process service and presenting the runtime data on the display device.

42. The method of claim 41, wherein the runtime data comprises message flow information.

43. The method of claim 40, wherein the debugging option is to place a breakpoint in the business process service.

44. The method of claim 40, further comprising presenting a content of a message according to the process.

45. The method of claim 40, further comprising receiving input from an input device to place a break point proximate a shape, and presenting a symbol representing the break point on the display device.

46. A computer-readable medium having computer-executable instructions for performing a method for debugging a business process service instance running on a remote computer, comprising:
if the business process service is in a debug mode, establishing a direct client connection channel with the remote computer;
causing an interceptor to monitor data regarding the business process service to find a location within the service based on stored state configuration;
receiving a runtime request; and
processing the runtime request at the remote computer with respect to the instance.

47. The computer-readable medium of claim 46, wherein the method further comprises:
querying a database containing a status of the business process service;
displaying a query result on a display device;
receiving user input with respect to the query result; and
establishing the direct client connection channel in response to the user input.

48. The computer-readable medium of claim 47, wherein the information contained in the database is instance runtime data.

49. The computer-readable medium of claim 47, wherein the information contained in the database is instance tracking data.

50. The computer-readable medium of claim 46, wherein the method further comprises:
creating the business process service using a process designer;
saving business process service configuration data in a database;
displaying a graphical representation of the business process service on a display device according to the saved business process service configuration data;
generating a runtime request based on the graphical representation; and
displaying a result of the runtime request on the display device.

51. The computer-readable medium of claim 50, wherein the graphical representation comprises a shape corresponding to an operation in the business process service.

52. The computer-readable medium of claim 50, wherein the graphical representation comprises a workflow representation of the business process service.

53. The computer-readable medium of claim 50, wherein the saving step takes place in connection with compiling and deploying the business process service.

54. The computer-readable medium of claim 50, wherein the business process service is implemented in a computer language that provides stored state information.

55. The computer-readable medium of claim 50, wherein the runtime request is a break point.

56. The computer-readable medium of claim 50, wherein the runtime request is a request for data regarding an instance of the business process service.

57. The computer-readable medium of claim 56, wherein the data regarding the instance is state information.

58. The computer-readable medium of claim 46, wherein the method further comprises detecting a location where the instance is being processed.

59. The computer-readable medium of claim 46, wherein the method further comprises detecting a location where an instance state is being stored.

60. A computer-readable medium having computer-executable instructions for performing a method for displaying on a display device a business process service debugger, the method comprising:
querying a database for configuration information regarding the business process service, wherein the configuration information contains an operation identifier;
receiving a query result and generating a shape representative of the operation according to the identifier; and
presenting the shape, the configuration information according to the query result, and a debugging option on the display device.

61. The computer-readable medium of claim 60, wherein the method further comprises receiving runtime data for the business process service and presenting the runtime data on the display device.

62. The computer-readable medium of claim 61, wherein the runtime data comprises message flow information.

63. The computer-readable medium of claim 60, wherein the debugging option is to place a breakpoint in the business process service.

64. The computer-readable medium of claim 60, wherein the method further comprises presenting a content of a message according to the process.

65. The computer-readable medium of claim 60, wherein the method further comprises receiving input from an input device to place a break point proximate a shape, and presenting a symbol representing the break point on the display device.
